(19) United States
(12) Patent Application Publication
(10) Pub. No.: US 2025/0200952 A1
(43) Pub. Date: Jun. 19, 2025

(54) LEARNING APPARATUS, LEARNING METHOD, PERSON VERIFICATION APPARATUS, PERSON VERIFICATION METHOD, AND RECORDING MEDIUM

(71) Applicant: NEC Corporation, Minato-ku, Tokyo (JP)

(72) Inventor: Yuta KUDO, Tokyo (JP)

(73) Assignee: NEC Corporation, Minato-ku, Tokyo (JP)

(21) Appl. No.: 18/844,438

(22) PCT Filed: Mar. 14, 2022
(86) PCT No.: PCT/JP2022/011276

§ 371 Date: Sep. 6, 2024

(51) Int. Cl. G06V 10/776; G06V 10/75; G06V 10/77

(52) U.S. Cl. CPC G06V 10/776; G06V 10/751; G06V 10/7715

(57) ABSTRACT

A learning apparatus that performs machine learning of a learning model, the learning apparatus including: an extraction unit that extracts a first sample feature quantity that is a feature quantity of a first sample person and a second sample feature quantity that is a feature quantity of a second sample person, by inputting a sample image including the first sample person who is the same as a verification subject and the second sample person who is different from the first sample person, to the learning model; and a learning unit that performs the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

### TECHNICAL FIELD

This disclosure relates to, for example, technical fields of a learning apparatus, a learning method, and a recording medium that are configured to perform machine learning of a learning model used to determine whether or not a person captured in an image is the same as a particular person (i.e., for verification), and a person verification apparatus, a person verification method, and a recording medium that are configured to determine whether or not a person captured in an image is the same as a particular person.

### BACKGROUND ART

Patent Literature 1 describes an example of the person verification apparatus that is configured to determine whether or not a person captured in an image is the same as a particular person. In addition, as prior art literatures regarding this disclosure, Patent Literatures 2 to 5 are cited.

### CITATION LIST

### Patent Literature

Patent Literature 1: JP2021-144749A
Patent Literature 2: JP2020-119154A
Patent Literature 3: JP2020-052694A
Patent Literature 4: JP2017-059207A
Patent Literature 5: JP2019-056966A

### SUMMARY

### Technical Problem

It is an example object of this disclosure to provide a learning apparatus, a learning method, a person verification apparatus, a person verification method, and a recording medium that are intended to improve the techniques/technologies described in Citation List.

### Solution to Problem

A learning apparatus according to an example aspect of this disclosure is a learning apparatus that performs machine learning of a learning model capable of outputting a feature quantity of a person when a person image including the person is inputted, the learning apparatus including: an extraction unit that extracts a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and a learning unit that performs the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

A person verification apparatus according to an example aspect of this disclosure is a person verification apparatus including: an extraction unit that extracts a target feature quantity that is a feature quantity of a target person, by inputting, as a person image, a target image including the target image, to a learning model capable of outputting a feature quantity of a person when the person image including the person is inputted; and a verification unit that determines whether or not the target person captured in the target image is the same as a first verification subject, on the basis of the target feature quantity, wherein the learning model is already learned by a learning method including: extracting a first sample feature quantity that is a feature quantity of a first sample person and a second sample feature quantity that is a feature quantity of a second sample person, by inputting, as the person image, a sample image including the first sample person who is the same as a second verification subject and the second sample person who is different from the first sample person, to the learning model; and performing machine learning of the learning model by using a first loss function regarding accuracy of verification processing of determining, on the basis of the first sample feature quantity, whether or not the first sample person captured in the sample image is the same as the second verification subject, and by using a second loss function regarding a distance between the first and second sample feature quantities.

A learning method according to an example aspect of this disclosure is a learning method that performs machine learning of a learning model capable of outputting a feature quantity of a person when a person image including the person is inputted, the learning method including: extracting a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and performing the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

A person verification method according to an example aspect of this disclosure is a person verification method including: extracting a target feature quantity that is a feature quantity of a target person, by inputting, as a person image, a target image including the target image, to a learning model capable of outputting a feature quantity of a person when the person image including the person is inputted; and determining whether or not the target person captured in the target image is the same as a first verification subject, on the basis of the target feature quantity, wherein the learning model is already learned by a learning method including: extracting a first sample feature quantity that is a feature quantity of a first sample person and a second sample feature quantity that is a feature quantity of a second sample person, by inputting, as the person image, a sample image including the first sample person who is the same as a second verification subject and the second sample person who is different from the first sample person, to the learning model; and performing machine learning of the learning model by using a first loss function regarding accuracy of verification processing of determining, on the basis of the first sample feature quantity, whether or not the first sample person captured in the sample image is the same as the second verification subject, and by using a second loss function regarding a distance between the first and second sample feature quantities.

A recording medium according to a first example aspect of this disclosure is a recording medium on which a computer program that allows a computer to execute a learning method is recorded, the learning method performing machine learning of a learning model capable of outputting a feature quantity of a person when a person image including the person is inputted, the learning method including: extracting a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and performing the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

A recording medium according to a second example aspect of this disclosure is a recording medium on which a computer program that allows a computer to execute a person verification method is recorded, the person verification method including: extracting a target feature quantity that is a feature quantity of a target person, by inputting, as a person image, a target image including the target image, to a learning model capable of outputting a feature quantity of a person when the person image including the person is inputted; and determining whether or not the target person captured in the target image is the same as a first verification subject, on the basis of the target feature quantity, wherein the learning model is already learned by a learning method including: extracting a first sample feature quantity that is a feature quantity of a first sample person and a second sample feature quantity that is a feature quantity of a second sample person, by inputting, as the person image, a sample image including the first sample person who is the same as a second verification subject and the second sample person who is different from the first sample person, to the learning model; and performing machine learning of the learning model by using a first loss function regarding accuracy of verification processing of determining, on the basis of the first sample feature quantity, whether or not the first sample person captured in the sample image is the same as the second verification subject, and by using a second loss function regarding a distance between the first and second sample feature quantities.

### BRIEF DESCRIPTION OF DRAWINGS

FIG. 1 is a block diagram illustrating a configuration of a learning apparatus in a first example embodiment.

FIG. 2 is a block diagram illustrating a configuration of a person verification apparatus in the first example embodiment.

FIG. 3 conceptually illustrates a learning operation performed by a learning apparatus in a second example embodiment.

FIG. 4 conceptually illustrates a person verification operation performed by a person verification apparatus in the second example embodiment.

FIG. 5 is a block diagram illustrating a configuration of the learning apparatus in the second example embodiment.

FIG. 6 is a data structure diagram illustrating an example of a data structure of a learning dataset. 10

FIG. 7 Each of FIG. 7A to FIG. 7C illustrates an example of a sample image.

FIG. 8 illustrates a camera image from which the sample image is cut out.

FIG. 9 conceptually illustrates a feature map outputted by a learning model to which a person image is inputted.

FIG. 10 is a flowchart illustrating a flow of the learning operation performed by the learning apparatus in the second example embodiment.

FIG. 11 is a block diagram illustrating a configuration of the person verification apparatus in the second example embodiment.

FIG. 12 is a flowchart illustrating a flow of the person verification operation performed by the person verification apparatus in the second example embodiment.

### DESCRIPTION OF EXAMPLE EMBODIMENTS

Hereinafter, with reference to the drawings, a learning apparatus, a learning method, a person verification apparatus, a person verification method, and a recording medium according to example embodiments will be described.

### (1) First Example Embodiment

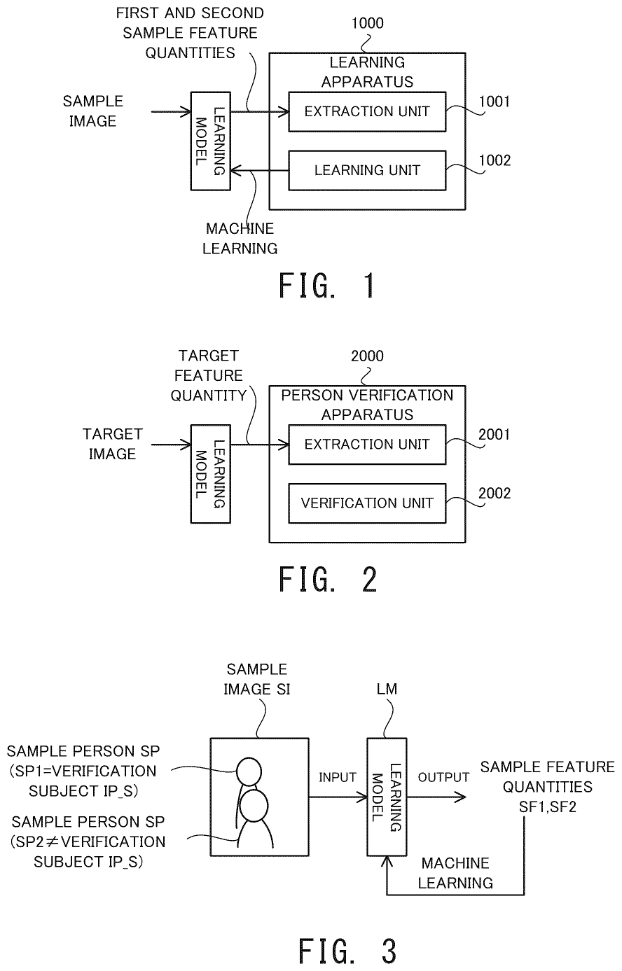

First, a learning apparatus, a learning method, a person verification apparatus, a person verification method, and a recording medium in a first example embodiment will be described. With reference to FIG. 1 and FIG. 2, the following describes the learning apparatus, the learning method, the person verification method, and the recording medium in the first example embodiment, by using a learning apparatus 1000 to which the learning apparatus, the learning method, and the recording medium in the first example embodiment are applied, and a person verification apparatus 2000 to which the person verification method, and the recording medium in the first example embodiment are applied. FIG. 1 is a block diagram illustrating a configuration of the learning apparatus 1000 in the first example embodiment. FIG. 2 is a block diagram illustrating a configuration of the person verification apparatus 2000 in the first example embodiment.

The learning apparatus 1000 performs machine learning of a learning model capable of outputting a feature quantity of a person when a person image including the person is inputted. In order to perform the machine learning of the learning model, the learning apparatus 1000 includes an extraction unit 1001 that is a specific example of the “extraction unit” described in Supplementary Note later, and a learning unit 1002 that is a specific example of the “learning unit” described in Supplementary Note later, as illustrated in FIG. 1.

The extraction unit 1001 inputs, as the person image, a sample image including: a first sample person who is the same as a second verification subject; and a second sample person who is different from the first sample person (i.e., who is different from the second verification subject), to the learning model. As a result, the learning model outputs a first sample feature quantity that is a feature quantity of the first sample person, and a second sample feature quantity that is a feature quantity of the second sample person. That is, the extraction unit 1001 extracts the first and second sample feature quantities by inputting the sample image to the learning model.

The learning unit 1002 performs the machine learning of the learning model, by using the first and second sample feature quantities extracted by the extraction unit 1001. Specifically, the learning unit 1002 performs the machine learning of the learning model, by using a first loss function and a second loss function. The first loss function is a loss function regarding accuracy of verification processing of determining whether or not the first sample person captured in the sample image is the same as the second verification subject, on the basis of the first sample feature quantity. The second loss function is a loss function regarding a distance between the first and second sample feature quantities.

The learning model built by the learning apparatus 1000 performing the machine learning (i.e., the learning model learned by the learning apparatus 1000) may be used by the person verification apparatus 2000 illustrated in FIG. 2. The person verification apparatus 2000 performs verification processing of determining whether or not a target person captured in a target image is the same as a first verification subject, by using the learning model. In order to perform the verification processing, as illustrated in FIG. 2, the person verification apparatus 2000 includes an extraction unit 2001 that is a specific example of the “extraction unit” described in Supplementary Note later, and a verification unit 2002 that is a specific example of the “verification unit” described in Supplementary Note later.

The extraction unit 2001 inputs, as the person image, the target image including the target person, to the learning model. As a result, the learning model outputs a target feature quantity serving as a feature quantity of the target person. That is, the extraction unit 2001 extracts the target feature quantity by inputting the target image to the learning model.

The verification unit 2002 performs verification processing of determining whether or not the target person captured in the target image is the same as the first verification subject, on the basis of the target feature quantity extracted by the extraction unit 2001.

As described above, the learning apparatus 1000 in the first example embodiment performs the machine learning of the learning model, by using the first loss function regarding the accuracy of the verification processing. Therefore, as compared with a case where the machine learning of the learning model is performed without using the first loss function, the learning apparatus 1000 is capable of performing the machine learning such that it is easily determined that the first sample person is the same as the second verification subject (i.e., the accuracy of the verification processing is improved), in a situation where the first and second sample persons are captured in one sample image. Consequently, the person verification apparatus 2000 using the learning model built by the learning apparatus 1000, is capable of properly determining that a first target person is the same as the first verification subject, even when one target image includes not only the first target person who is the same as the first verification subject, but also a second target person who is different from the first target person.

In addition, the learning apparatus 1000 in the first example embodiment performs the machine learning of the learning model, by using a second loss function regarding the distance between the first and second sample feature quantities, in addition to the first loss function. For example, the learning apparatus 1000 may perform the machine learning of the learning model to increase the distance between the first and second sample feature quantities (i.e., to lower a degree of similarity between the first and second sample feature quantities). Therefore, as compared with a case where the machine learning of the learning model is performed without using the second loss function, the learning apparatus 1000 is capable of performing the machine learning to hardly erroneously determine that the second sample person is the same as the second verification subject (i.e., to improve the accuracy of the verification processing) in the situation where the first and second sample persons are captured in one sample image. Consequently, the person verification apparatus 2000 using the learning model built by the learning apparatus 1000, is less likely to erroneously determine that the second target person is the same as the first verification subject, even when the first and second target persons are captured in one target image.

As described above, the learning apparatus 1000 is capable of performing the machine learning of the learning model such that the first target person is properly determined to be the same as the first verification subject by the person verification apparatus 2000 and such that the second target person is not erroneously determined to be the same as the first verification subject, in the situation where the first and second target persons are captured in one target image. Consequently, the person verification apparatus 2000 is capable of properly determining that the first target person is the same as the first verification subject, in the situation where the first and second target persons are captured in one target image.

### (2) Second Example Embodiment

Next, a learning apparatus, a learning method, a person verification apparatus, a person verification method, and a recording medium in a second example embodiment will be described. The following describes the learning apparatus, the learning method, the person verification method, and the recording medium in the second example embodiment, by using a learning apparatus 1 to which the learning apparatus, the learning method, and the recording medium in the second example embodiment are applied, and a person verification apparatus 2 to which the person verification method, and the recording medium in the second example embodiment are applied.

The learning apparatus 1 performs a learning operation for performing machine learning of a learning model LM that is learnable. The learning model LM is a model capable of outputting the feature quantity of a person when a person image including the person is inputted. The learning model LM may be, for example, a learning model including a neural network.

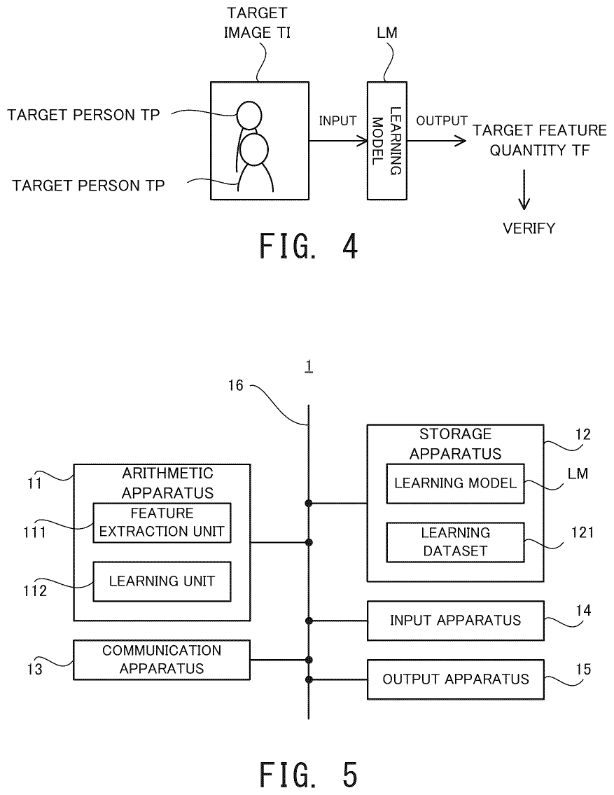

In order to perform the learning operation, the learning apparatus 1 inputs a sample image SI that is a specific example of the person image, to the learning model LM as illustrated in FIG. 3. The sample image SI is, for example, an image including a sample person SP who is the same as a verification subject IP_S and a sample person SP who is not the same as the verification subject IP_S. Consequently, the learning model LM outputs a plurality of sample feature quantities SF that are feature quantities of a plurality of sample persons SP. The learning apparatus 1 performs the machine learning of the learning model LM by using the plurality of sample feature quantities SF. In the following explanation, as needed, the sample person SP who is the same as the verification subject IP_S will be referred to as a “sample person SP1”, the sample person SP who is not the same as the verification subject IP_S will be referred to as a “sample person SP2”, the sample feature quantity SF of the sample person SP1 will be referred to as a “sample feature quantity SF1”, and the sample feature quantity SF of the sample person SP2 will be referred to as a “sample feature quantity SF2”.

On the other hand, the person verification apparatus 2 performs a person verification operation for determining whether or not the person in the person image is the same as a particular person, by using the learning model LM. The learning model LM used by the person verification apparatus 2 is the learning model LM built by the learning apparatus 1 (i.e., the learning model LM built by the machine learning performed by the learning apparatus 1). That is, the learning model LM used by the person verification apparatus 2 is the learning model LM already learned by the learning apparatus 1.

In order to perform the person verification operation, the person verification apparatus 2 inputs a target image TI that is a specific example of the person image, to the learning model LM as illustrated in FIG. 4. The target image is an image including a target person TP. The target image TI may include a plurality of target persons TP. As a result, the learning model LM outputs a target feature quantity TF that is a feature quantity of the target person TP. The person verification apparatus 2 determines whether or not the target person TP captured in the target image TI is the same as a verification subject IP_T by using the target feature quantity TF. That is, the person verification apparatus 2 uses the target feature quantity TF to identify the verification subject IP_T who is the same as the target person TP captured in the target image TI.

Hereinafter, the learning apparatus 1 and the person verification apparatus 2 will be described in order.

### (2-1) Learning Apparatus 1 in Second Example Embodiment

First, the learning apparatus 1 in the second example embodiment will be described.

### (2-1-1) Configuration of Learning Apparatus

First, with reference to FIG. 5, the learning apparatus 1 in the second example embodiment will be described. FIG. 3 is a block diagram illustrating a configuration of the learning apparatus 1 in the second example embodiment.

As illustrated in FIG. 5, the learning apparatus 1 includes an arithmetic apparatus 11 and a storage apparatus 12. Furthermore, the learning apparatus 1 may include a communication apparatus 13, an input apparatus 14, and an output apparatus 15. The learning apparatus 1, however, may not include at least one of the communication apparatus 13, the input apparatus 14, and the output apparatus 15. The arithmetic apparatus 11, the storage apparatus 12, the communication apparatus 13, the input apparatus 14, and the output apparatus 15 may be connected through a data bus 16.

The arithmetic apparatus 11 includes at least one of a CPU (Central Processing Unit), a GPU (Graphics Processing Unit), a FPGA (Field Programmable Gate Array), for example. The arithmetic apparatus 11 reads a computer program. For example, the arithmetic apparatus 11 may read a computer program stored in the storage apparatus 12. For example, the arithmetic apparatus 11 may read a computer program stored by a computer-readable and non-transitory recording medium, by using a not-illustrated recording medium reading apparatus provided in the learning apparatus 1. The arithmetic apparatus 11 may acquire (i.e., download or read) a computer program from a not-illustrated apparatus disposed outside the learning apparatus 1, through the communication apparatus 13 (or another communication apparatus). The arithmetic apparatus 11 executes the read computer program. Consequently, a logical functional block for performing an operation to be performed by the learning apparatus 1 (e.g., the learning operation described above) is realized or implemented in the arithmetic apparatus 11. That is, the arithmetic apparatus 11 is allowed to function as a controller for realizing or implementing the logical functional block for performing an operation to be performed by the learning apparatus 1.

FIG. 5 illustrates an example of the logical functional block realized or implemented in the arithmetic apparatus 11 to perform the learning operation. As illustrated in FIG. 5, a feature extraction unit 111 that is a specific example of the “extraction unit” described in Supplementary Note later and a learning unit 112 that is a specific example of the “learning unit” described in Supplementary Note later, are realized or implemented in the arithmetic apparatus 11. Although the respective operations of the feature extraction unit 111 and the learning unit 112 will be described in detail later, an outline thereof will be briefly described here. The feature extraction unit 111 inputs the sample image SI to the learning model LM, thereby extracting the sample feature quantity SF of the sample person SP captured in the sample image SI. The learning unit 112 performs the machine learning of the learning model LM on the basis of the sample feature quantity SF extracted by the feature extraction unit 111.

The storage apparatus 12 is configured to store desired data. For example, the storage apparatus 12 may temporarily store a computer program to be executed by the arithmetic apparatus 11. The storage apparatus 12 may temporarily store data that are temporarily used by the arithmetic apparatus 11 when the arithmetic apparatus 11 executes the computer program. The storage apparatus 12 may store data that are stored by the learning apparatus 1 for a long time. The storage apparatus 12 may include at least one of a RAM (Random Access Memory), a ROM (Read Only Memory), a hard disk apparatus, a magneto-optical disk apparatus, an SSD (Solid State Drive), and a disk array apparatus. That is, the storage apparatus 12 may include a non-transitory recording medium.

Especially in the second example embodiment, the storage apparatus 12 may be configured to store the learning model LM that is a target of the machine learning.

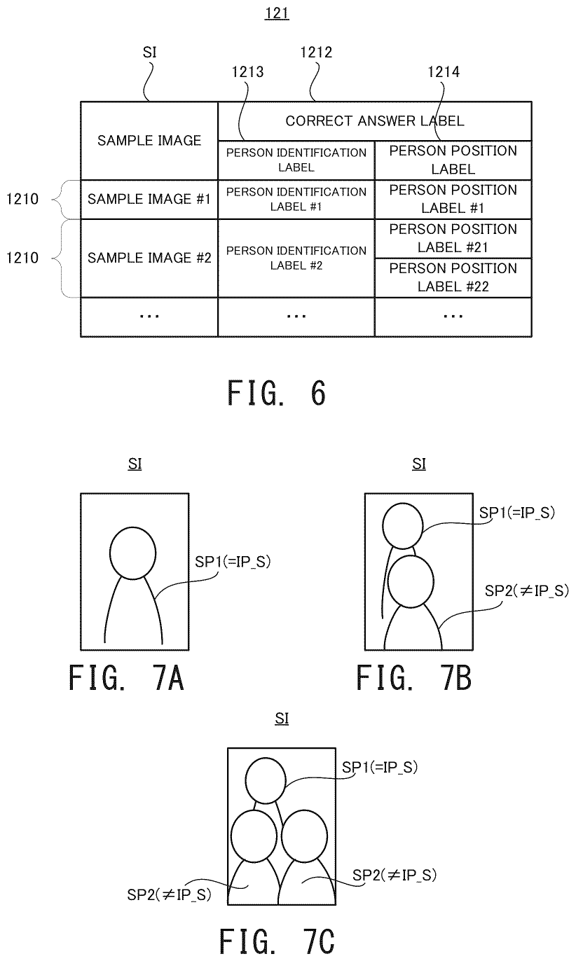

Additionally, the storage apparatus 12 may be configured to store a learning dataset 121 including the sample image SI used for the machine learning. FIG. 6 illustrates an example of a data structure for the learning dataset 121. As illustrated in FIG. 6, the learning dataset 121 may include a plurality of pieces of unit learning data 1210.

Each piece of unit learning data 1210 may include the sample image SI described above. The sample image SI is an image including at least one sample person SP1 who is the same as the verification subject IP_S corresponding to the sample image SI. In this instance, at least one of the plurality of pieces of unit learning data 1210 may include a sample image SI including one sample person SP1, but not including the sample person SP2 who is not the same as the verification subject IP_S, as illustrated in FIG. 7A. At least one of the plurality of pieces of unit learning data 1210 may include a sample image SI including the sample person SP2, in addition to one sample person SP1, as illustrated in FIG. 7B. FIG. 7 (b) illustrates the sample image SI including one sample person SP1 and one sample person SP2. At least one of the plurality of pieces of unit learning data 1210, however, may include a sample image SI including one sample person SP1 and a plurality of sample persons SP2, as illustrated in FIG. 7C.

As illustrated in FIG. 8, the sample image SI may be an image generated by performing object detection processing (in other words, person detection processing) for detecting a captured person CP captured in a camera image CI, on the camera image CI captured by a camera, and by cutting out the captured person CP detected by the object detection processing from the camera image CI. The object detection processing may be processing of detecting the captured person CP by a unit of a bounding box Ba that at least partially surrounds the captured person CP captured in the camera image CI. In this instance, the sample image SI may be an image generated by cutting out an image part included in the bounding box Ba from the camera image CI. In this instance, the person CP surrounded by the bounding box Ba (i.e., the captured person CP identified by the unit of the bounding box Ba) is the verification subject IP_S and the sample person SP1 in the sample image SI generated by cutting out the image part included in the bounding box Ba from the camera image CI. On the other hand, the bounding box Ba may include a captured person CP who is different from the captured person CP detected by the object detection processing. For example, when a plurality of captured persons CP who at least partially overlap is captured in the camera image CI, the bounding box Ba surrounding one of the plurality of captured persons CP may include another captured person CP who is different from one of the plurality of captured persons CP. In this instance, the captured person CP who is different from the captured person CP detected by the object detection processing, is the sample person SP2 in the sample image SI generated by cutting out the image part included in the bounding box Ba from the camera image CI.

In the example illustrated in FIG. 8, a captured person CP #1 and a captured person CP #2 partially overlap in the captured image CI, a bounding box Ba #1 surrounding the captured person CP #1 includes the captured person CP #2, and a bounding box Ba #2 surrounding the captured person CP #2 includes the captured person CP #1. In this case, in the sample image SI generated by cutting out the image part included in the bounding box Ba #1 from the camera image CI, the captured person CP #1 is the verification subject IP_S and the sample person SP1, and the captured person CP #2 is the sample person SP2. In addition, in the sample image SI generated by cutting out the image part included in the bounding box Ba #2 from the camera image CI, the captured person CP #2 is the verification subject IP_S and the sample person SP1, and the captured person CP #1 is the sample person SP2.

Referring again to FIG. 6, each piece of unit learning data 1210 may further include a correct answer label 1212. The correct answer label 1212 may include a person identification label 1213 and a person position label 1214.

The person identification label 1213 is identification information (e.g., a person ID) that allows identification of the verification subject IP_S who is to be determined to be the same as the sample person SP1 captured in the sample image SI. For example, the unit learning data 1210 including the sample image SI including the sample person SP1 who is the same as a verification subject IP_S of “A”, may include identification information that allows the identification of the verification subject IP_S of “A”, as the person identification label 1213.

The person position label 1214 is information indicating a position of the sample person

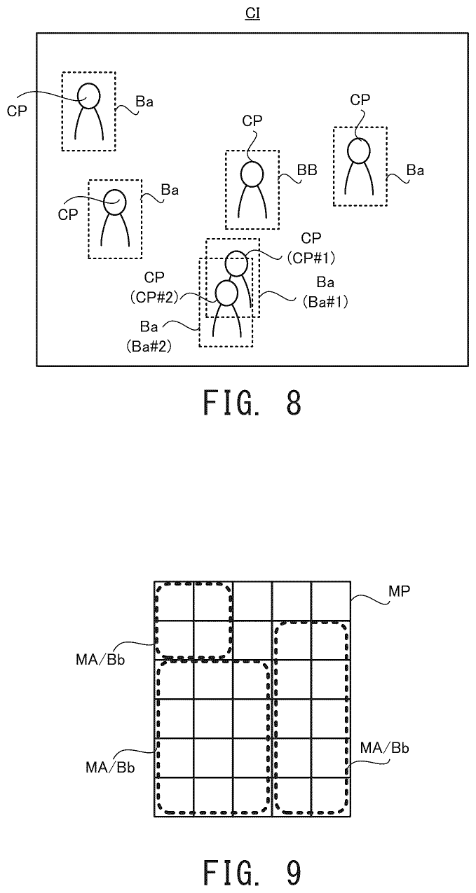

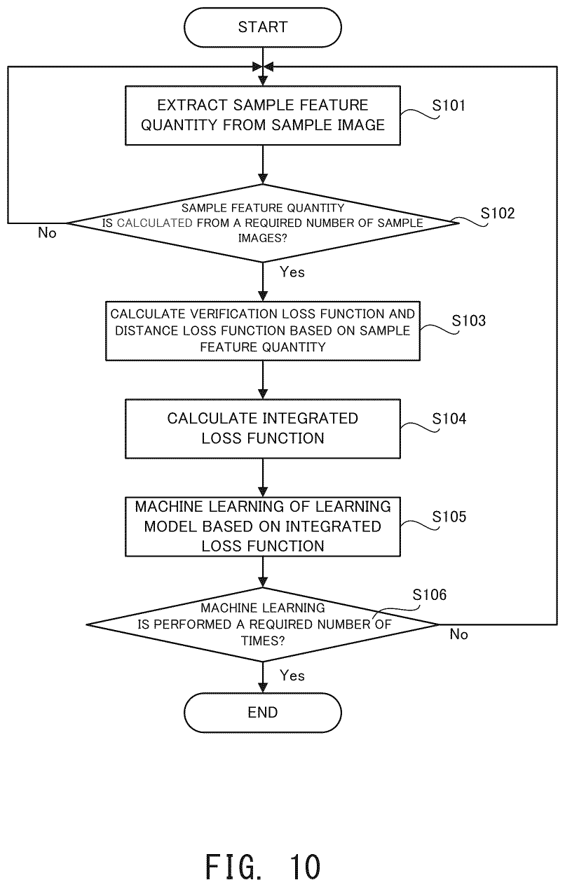

SP captured in the sample image SI. Specifically, in the second example embodiment, the learning model LM to which the person image (in this case, the sample image SI) is inputted, outputs a feature map MP in which the feature quantity of the person image is mapped, and map position information indicating a position of a map area MA corresponding to the person captured in the person image, of the feature map MP, as illustrated in FIG. 9. In other words, the learning model LM outputs the feature map MP and the map position information indicating the position of the map area MA including the feature quantity of the person captured in the person image, of the feature map MP. The following describes an example in which the map position information indicates the position of the map area MA by using a bounding box Bb surrounding the map area MA, as illustrated in FIG. 9. In this case, the person position label 1214 indicates the bounding box Bb to be outputted by the learning model LM (i.e., the position of the map area MA to be outputted by the learning model LM) when the sample image SI corresponding to the person position label 1214 is inputted to the learning model LM.

As described above, the sample image SI may include the plurality of sample persons SP. In this instance, the learning model LM to which the sample image SI is inputted, outputs a plurality of bounding boxes Bb respectively indicating positions of a plurality of map areas MA respectively including the feature quantities of the plurality of sample persons SP, of the feature map MP. In this instance, the unit learning data 1210 including the sample image SI may include a plurality of person position labels 1214 respectively indicating the plurality of bounding boxes Bb to be outputted by the learning model LM. In the example illustrated in FIG. 9, when a sample image SI including three sample persons SI is inputted to the learning model LM, outputted are three bounding boxes Bb respectively indicating the positions of three map areas MA respectively including the feature quantities of the three sample persons SP, of the feature map MP. In this instance, the unit learning data 1210 including the sample image SI may include three person position labels 1214 respectively indicating the three bounding boxes Bb to be outputted by the learning model LM.

Referring back to FIG. 5, the communication apparatus 13 is configured to communicate with an apparatus external to the learning apparatus 1. For example, the communication apparatus 13 may be configured to communicate with the person verification apparatus 2. In this instance, the learning apparatus 1 may transmit (i.e., output) the learning model LM built by the machine learning, to the person verification apparatus 2 through the communication apparatus 13.

The input apparatus 14 is an apparatus that receives an input of information to the learning apparatus 1 from the outside of the learning apparatus 1. For example, the input apparatus 14 may include an operating apparatus (e.g., at least one of a keyboard, a mouse, and a touch panel) that is operable by an operator of the learning apparatus 1. For example, the input apparatus 14 may include a reading apparatus that is configured to read information recorded as data on a recording medium that is externally attachable to the learning apparatus 1.

The output apparatus 15 is an apparatus that outputs information to the outside of the learning apparatus 1. For example, the output apparatus 15 may output information as an image. That is, the output apparatus 15 may include a display apparatus (a so-called display) that is configured to display an image indicating the information that is desirably outputted. For example, the output apparatus 15 may output information as audio/sound. That is, the output apparatus 15 may include an audio apparatus (a so-called speaker) that is configured to output the audio/sound. For example, the output apparatus 15 may output information onto a paper surface. That is, the output apparatus 15 may include a print apparatus (a so-called printer) that is configured to print desired information on the paper surface.

### (2-1-2) Learning Operation Performed by Learning Apparatus 1

Next, with reference to FIG. 10, a learning operation performed by the learning apparatus 1 in the second example embodiment will be described. FIG. 10 is a flowchart illustrating a flow of the learning operation performed by the learning apparatus 1 in the second example embodiment.

As illustrated in FIG. 10, the feature extraction unit 111 extracts the sample feature quantity SF from the sample image SI (step S101). Specifically, the feature extraction unit 111 inputs one sample image SI included in the learning dataset 121, to the learning model LM. Consequently, the learning model LM outputs the sample feature quantity SF of the sample person SP captured in the sample image SI. Specifically, as described above, when the sample image SI is inputted to the learning model LM, the learning model LM outputs the feature map MP and the bounding box Bb indicating the position of the map area MA including the feature quantity of the sample person SP, of the feature map MP. In this instance, the feature extraction unit 111 may extract the sample feature quantity SF, by using the map area MA surrounded by the bounding box Bb, of the feature map MP. For example, the feature extraction unit 111 may extract a one-dimensional or multi-dimensional vector representing the feature quantity included in the map area MA, as the sample feature quantity. For example, the feature extraction unit 111 may extract a one-dimensional or multi-dimensional vector representing an arithmetic value or statistic (e.g., an average value) of feature quantities included in the map area MA, as the sample feature quantity. In this instance, it may be considered that the learning model LM outputs the feature map MP and the bounding box Bb, thereby substantially outputting the sample feature quantity SF that is extractable on the basis of the feature map MP and the bounding box Bb.

As described above, the sample image SI may include the plurality of sample persons SP. In this instance, the learning model LM to which the sample image SI is inputted, outputs the plurality of bounding boxes Bb respectively indicating the positions of the plurality of map areas MA respectively including the feature quantities of the plurality of sample persons SP, of the feature map MP. The feature extraction unit 111 may extract the sample feature quantity SF of each sample person SP, by using the map area MA corresponding to each sample person SP. For example, when one sample person SP1 is captured in the sample image SI, the feature extraction unit 111 may extract the sample feature quantity SF1 of the sample person SP1 by using the map area MA corresponding to the sample person SP1. For example, when one sample person SP2 is captured in the sample image SI, the feature extraction unit 111 may extract the sample feature quantity SF2 of the sample person SP2 by using the map area MA corresponding to the sample person SP2. For example, when a plurality of sample persons SP2 are captured in the sample image SI, the feature extraction unit 111 may extract the sample feature quantity SF2 of one sample person SP2 by using one map area MA corresponding to one of the plurality of sample persons SP2.

Thereafter, the feature extraction unit 111 repeats the processing of extracting the sample feature quantity SF in the step S101, until the sample feature quantity SF is extracted from a required number of sample images SI (step S102).

Thereafter, the learning unit 112 calculates a verification loss function Loss1 and a distance loss function Loss2 on the basis of the sample feature quantity SF extracted in the step S101 (step S103).

The verification loss function Loss1 is a loss function regarding the accuracy of verification processing of determining whether or not the sample person SP1 captured in the sample image SI (i.e., the sample person SP1 who is to be determined to be the same as the verification subject IP_S) is the same as the verification subject IP_S, on the basis of the sample feature quantity SF extracted in the step S101. Typically, the verification loss function Loss1 may be a loss function that becomes smaller as the accuracy of the verification processing increases.

In order to calculate verification loss function Loss1, the learning unit 112 performs the verification processing of determining whether or not the sample person SP1 captured in the sample image SI is the same as the verification subject IP_S in the sample image SI, on the basis of the sample feature quantity SF. Specifically, the learning unit 112 performs the verification processing of determining whether or not the sample person SP1 captured in one sample image SI is the same as the verification subject IP_S in the one sample image SI, on the basis of the sample feature quantity SF extracted from the one sample image SI. Thereafter, the learning unit 112 calculates an error between a result of the verification processing using one sample image SI and the person identification label 1213 corresponding to the one sample image SI. An example of the error may be at least one of squared error and cross entropy, but the error is not limited to this example. As the accuracy of the verification processing using one sample image SI increases, a probability increases that the sample person SP1 captured in one sample image SI is determined, by the verification processing, to be the same as the verification subject IP_S indicated by the person identification label 1213 corresponding to the one sample image SI. As a result, the error is reduced between the result of the verification processing and the person identification label 1213. On the other hand, as the accuracy of the verification processing using one sample image SI decreases, a probability decreases that the sample person SP1 captured in one sample image SI is determined, by the verification processing, to be the same as the verification subject IP_S indicated by the person identification label 1213 corresponding to the one sample image SI. As a result, the error becomes larger between the result of the verification processing and the person identification label 1213. The learning unit 112 repeats the same processing by the number of the sample images SI inputted to the learning model LM. Thereafter, the learning unit 112 may calculate a sum of a plurality of calculated errors (or any arithmetic value or statistic), as the verification loss function Loss1.

As an example, the learning unit 112 may input the sample feature quantity SF extracted in the step S101 from one sample image SI, to a class classifier. When a plurality of sample feature quantities SF are extracted in the step S101 due to a plurality of sample persons SP captured in one sample image SI, the learning unit 112 may input the plurality of sample feature quantities SF extracted from the one sample image SI, to the class classifier. Alternatively, the learning unit 112 may selectively input a part of the plurality of sample feature quantities SF extracted from one sample image SI, to the class classifier. When the feature quantity extracted from the person image is inputted, the class classifier is capable of outputting a classification result of a class of the person captured in the person image, as a probability distribution. An example of such a class classifier may be a class classifier including a fully-combining layer that combines the inputted feature quantities into one node, and an output layer that uses a softmax function to convert an output of the fully-combining layer into a probability distribution including a plurality of probabilities in which persons captured in the person image are respectively classified into a plurality of classes. In this case, the class classifier to which the sample feature quantity SF is inputted, outputs a probability distribution indicating the probability that the sample person SP1 captured in the sample image SI is the same as each of a plurality of different verification subjects IP_S. The learning unit 112 repeats the same processing by the number of the sample images SI from which the sample feature quantity SF is extracted. Thereafter, the learning unit 112 may calculate the verification loss function Loss1 on the basis of a plurality of calculated probability distributions. In this instance, a loss function based on softmax loss may be used as the verification loss function Loss1. Alternatively, when the person identification label 1213 indicates, by using the probability distribution, the verification subject IP_S who is to be determined to be the same as the sample person SP1 captured in one sample image SI, a loss function based on cross entropy may be used as the verification loss function Loss1.

The verification loss function Loss1 calculated in this manner is a loss function that becomes smaller as the accuracy of the verification processing increases. That is, the verification loss function Loss1 is a loss function that becomes smaller as the probability increases that the sample person SP1 is determined to be the same as the subject IP_S by the verification processing.

On the other hand, the distance loss function Loss2 is a loss function regarding a distance between the sample feature quantity SF1 of the sample person SP1 who is to be determined to be the same as the verification subject IP_S, and the sample feature quantity SF2 of the sample person SP2 who is not to be determined to be the same as the verification subject IP_S. Therefore, the learning unit 112 calculates the distance loss function Loss2 by using the sample feature quantities SF1 and SF2 extracted from the sample image SI including both the sample persons SP1 and SP2. The learning unit 112 may calculate the distance loss function Loss2, without using the sample feature quantity SF1 extracted from the sample image SI including the sample person SP1, but not including the sample person SP2.

In order to calculate the distance loss function Loss2, the learning unit 112 calculates the distance between the sample feature quantities SF1 and SF2 extracted from one sample image SI including both the sample persons SP1 and SP2. The distance between the sample feature quantities SF1 and SF2 may mean a distance between the sample feature quantities SF1 and SF2 in a vector space of the sample feature quantity SF. As the distance, Euclidean distance may be used, or another type of distance (e.g., at least one of Mahalanobis distance, check sheet chef distance, and Manhattan distance) may be used. The learning unit 112 repeats the processing of calculating the distance between the sample feature quantities SF1 and SF2, by the number of the sample images SI from which both the sample feature quantities SF1 and SF2 are extracted. Thereafter, the learning unit 112 may calculate the distance loss function Loss2 on the basis of a plurality of calculated distances. For example, the learning unit 112 may calculate the distance loss function Loss2 that becomes smaller as the plurality of distances become longer, on the basis of the plurality of calculated distances. For example, the learning unit 112 may calculate the distance loss function Loss2 that becomes smaller as each of the plurality of calculated distances approaches a predetermined margin distance (e.g., a loss term for an inter-class sample of Contrastive Loss).

As the distance is increased between the sample feature quantities SF1 and SF2, a degree of similarity decreases between the sample feature quantities SF1 and SF2. In other words, as the distance is reduced between sample feature quantities SF1 and SF2, the degree of similarity increases between sample feature quantities SF1 and SF2. Therefore, the distance between the sample feature quantities SF1 and SF2 may be considered equivalent to the degree of similarity between the sample feature quantities SF1 and SF2.

Thereafter, the learning unit 112 integrates the verification loss function Loss1 and the distance loss function Loss2 calculated in the step S103, thereby calculating an integrated loss function Loss (step S104). The integrated loss function Loss may be any loss function as long as both the verification loss function Loss1 and the range loss function Loss2 are reflected. For example, the learning unit 112 may calculate the integrated loss function Loss by adding the verification loss function Loss1 and the distance loss function Loss2. For example, the learning unit 112 may calculate the integrated loss function Loss by adding the verification loss function Loss1 and the distance loss function Loss2 each of which is multiplied by a weighting factor.

Thereafter, the learning unit 112 performs the machine learning of the learning model LM such that the integrated loss function Loss calculated in the step S104 becomes smaller (preferably, minimized) (step S105). For example, when the learning model LM includes a neural network, the learning unit 112 may update a parameter (e.g., at least one of a weight and a bias) of the neural network.

Thereafter, the learning unit 112 may repeat the step S101 to the step S105 until the machine learning of the learning model LM in the step S105 is performed a required number of times (e.g., a number of times corresponding to a set epoch number) (step S106).

### (2-2) Person Verification Apparatus 2 in Second Example Embodiment

Next, the person verification apparatus 2 in the second example embodiment will be described.

### (2-2-1) Configuration of Person Verification Apparatus 2

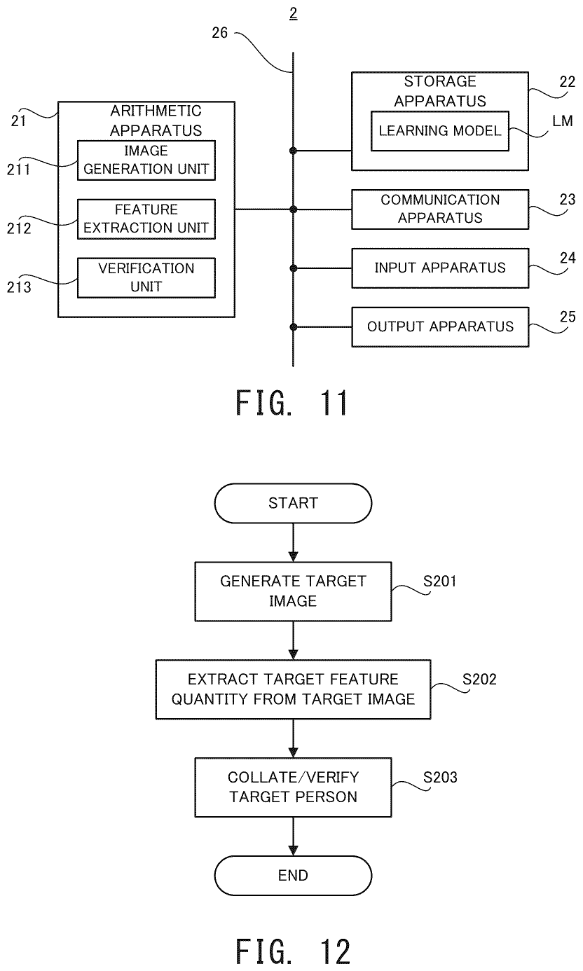

First, with reference to FIG. 11, the person verification apparatus 2 in the second example embodiment will be described. FIG. 11 is a block diagram illustrating a configuration of the person verification apparatus 2 in the second example embodiment.

As illustrated in FIG. 3, the person verification apparatus 2 includes an arithmetic apparatus 21 and a storage apparatus 22. The person verification apparatus 2 may further include a communication apparatus 23, an input apparatus 24, and an output apparatus 25. The person verification apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes, for example, at least one of a CPU, a GPU, and a FPGA. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the person verification apparatus 2. The arithmetic apparatus 21 may acquire (i.e., download or read) a computer program from a not-illustrated apparatus disposed outside the person verification apparatus 2, through the communication apparatus 23 (or another communication apparatus). The arithmetic apparatus 21 executes the read computer program. Consequently, a logical functional block for performing an operation to be performed by the person verification apparatus 2 (e.g., the person verification operation described above) is realized or implemented in the arithmetic apparatus 21. That is, the arithmetic apparatus 21 is allowed to function as a controller for realizing or implementing the logical functional block for performing an operation to be performed by the person verification apparatus 2.

FIG. 11 illustrates an example of the logical functional block realized or implemented in the arithmetic apparatus 21 to perform the person verification operation. As illustrated in FIG. 11, an image generation unit 211, a feature extraction unit 212 that is a specific example of the “extraction unit” described in Supplementary Note later, and a verification unit 213 that is a specific example of the “verification unit” described in Supplementary Note described later, are realized or implemented in the arithmetic apparatus 21. Although the respective operations of the image generation unit 211, the feature extraction unit 212, and verification unit 213 will be described in detail later, an outline thereof will be briefly described here. The image generation unit 211 generates the target image TI. The feature extraction unit 212 extracts the target feature quantity TF of the target person TP captured in the target image TI, by inputting the target image TI to the learning model LM. The verification unit 213 performs verification processing of determining whether or not the target person TP captured in the target image TI is the same as the verification subject IP_T on the basis of the target feature quantity TF extracted by the feature extraction unit 212.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the person verification apparatus 2 for a long time. The storage apparatus 22 may include at least one of a RAM (Random Access Memory), a ROM (Read Only Memory), a hard disk apparatus, a magneto-optical disk apparatus, an SSD (Solid State Drive), and a disk array apparatus. That is, the storage apparatus 22 may include a non-transitory recording medium.

Especially in the second example embodiment, the storage apparatus 22 may be configured to store the learning model LM built by the learning apparatus 1 (i.e., built by the machine learning performed by the learning apparatus 1).

The communication apparatus 23 is configured to communicate with an apparatus external to the person verification apparatus 2. For example, the communication apparatus 23 may be configured to communicate with the learning apparatus 1. In this instance, the person verification apparatus 2 may receive (i.e., acquire) the learning model LM built by the learning apparatus 1, from the learning apparatus 1 through the communication apparatus 23.

The input apparatus 24 is an apparatus that receives an input of information to the person verification apparatus 2 from the outside of the person verification apparatus 2. For example, the input apparatus 24 may include an operating apparatus (e.g., at least one of a keyboard, a mouse, and a touch panel) that is operable by an operator of the person verification apparatus 2. For example, the input apparatus 24 may include a reading apparatus that is configured to read information recorded as data on a recording medium that is externally attachable to the person verification apparatus 2.

The output apparatus 25 is an apparatus that outputs information to the outside of the person verification apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output the audio/sound. For example, the output apparatus 25 may output information onto a paper surface. That is, the output apparatus 25 may include a print apparatus (a so-called printer) that is configured to print desired information on the paper surface.

### (2-2-2) Person Verification Operation Performed by Person Verification Apparatus

Next, with reference to FIG. 12, the person verification operation performed by the person verification apparatus 2 in the second example embodiment will be described. FIG. 12 is a flowchart illustrating a flow of the person verification operation performed by the person verification apparatus 2 in the second example embodiment.

As illustrated in FIG. 12, the image generation unit 211 generates the target image TI (step S201). For example, the image generation unit 211 may generate the target image TI in the same manner as the method of generating the sample image SI used in the learning operation described above. Specifically, for example, the image generation unit 211 may acquire a camera image captured by a camera for generating the target image TI. Thereafter, the image generation unit 211 may perform the object detection processing for detecting a captured person captured in the camera image, on the acquired camera image. Thereafter, the image generation unit 211 may generate the target image TI including the captured person, by cutting out the captured person detected by the object detection processing from the camera image.

Similar to the sample image SI illustrated in FIG. 7A, one target person TP may be captured in the target image TI. Similar to the sample image SI illustrated in each of FIG. 7B and FIG. 7C, a plurality of target persons TP may be captured in the target image TI.

When the target image TI is generated in advance, the image generation unit 211 may not generate the target image TI. For example, the camera image itself may be used as the target image TI. In this instance, the person verification apparatus 2 may not include the image generation unit 211.

Thereafter, the feature extraction unit 212 extracts the target feature quantity TF from the target image TI generated in the step S201 (step S202). Specifically, the feature extraction unit 212 inputs the target image TI to the learning model LM. As a consequence, the learning model LM outputs the target feature quantity TF of the target person TP captured in the target image TI. The operation of the feature extraction unit 212 extracting the target feature quantity TF from the target image TI in the step S202 may be the same as the operation of the feature extraction unit 111 extracting the sample feature quantity SF from the sample image SI in the step S101 in FIG. described above. Therefore, a detailed description of the operation of the feature extraction unit 212 extracting the target feature quantity TF from the target image TI in the step S202 will be omitted.

Thereafter, the verification unit 213 performs the verification processing of determining whether or not the target person TP captured in the target image TI is the same as the verification subject IP_T on the basis of the target feature quantity TF extracted in the step S202 (step S203). Specifically, the verification unit 213 performs the verification processing of determining whether or not the target person TP captured in the target image TI is the same as each of a plurality of different verification subjects IP_T on the basis of the target feature quantity TF. That is, the verification unit 213 performs the verification processing of identifying the verification subject IP_T who is the same as the target person TP captured in the target image TI, from the plurality of different verification subjects IP_T, on the basis of the target feature quantity TF extracted in the step S202.

For example, the verification unit 213 calculates a degree of similarity between the target person T_P captured in the target image TI and each of the plurality of different verification subjects IP_T, by comparing the target feature quantity TF extracted in the step S202 with a verification subject feature quantity that is a feature quantity of each of the plurality of different verification subjects IP_T. The verification subject feature quantity that is the feature quantity of each of the plurality of different verification subjects IP_T, may be stored in advance in the storage apparatus 22. Thereafter, the verification unit 213 may determine that the target person TP captured in the target image TI is the same as one verification subject IP_T having the highest degree of similarity, of the plurality of different verification subjects P_T.

As described above, the target image TI may include the plurality of target persons TP. In this instance, the feature extraction unit 212 calculates the target feature quantity TF of each of the plurality of target persons TP in the step S202. The verification unit 213 may calculate a degree of similarity between each of the plurality of target persons TP captured in the target image TI and each of the plurality of verification subjects IP_T, by comparing each of a plurality of target feature quantities TF extracted in the step S202 and the verification subject feature quantity of each of the plurality of different verification subjects IP_T. Thereafter, when the degree of similarity becomes the highest between one of the plurality of target persons TP captured in the target image TI and one of the plurality of different verification subjects IP_T, the verification unit 213 may determine that the one target person TP captured in the target image TI is the same as the one verification subject IP_T.

### (2-3) Technical Effect

As described above, the learning apparatus 1 in the second example embodiment performs the machine learning of the learning model LM by using the verification loss function Loss1 regarding the accuracy of the verification processing. Therefore, as compared with a case where the machine learning of the learning model LM is performed without using the verification loss function Loss1, the learning apparatus 1 is capable of performing the machine learning such that the sample person SP1 who is the same as the verification subject IP_S, is easily determined to be the same as the verification subject IP_S (i.e., the accuracy of the verification processing is improved) in a situation where the sample persons SP1 and SP2 are captured in one sample image SI. Consequently, the person verification apparatus 2 using the learning model LM built by the learning apparatus 1, is capable of properly determining that a first target person TP is the same as the verification subject IP_T, even when one target image TI includes not only the first target person TP who is the same as the verification subject IP_T, but also a second target person TP who is different from the verification subject IP_T. That is, even when a plurality of target persons TP are captured in one target image TI, the person verification apparatus 2 is capable of properly identifying one verification subject IP_T who is the same as one of the plurality of target persons TP, from the plurality of different verification subjects IP_T.

In addition, the learning apparatus 1 in the second example embodiment performs the machine learning of the learning model LM by using the distance loss function Loss2 in addition to the verification loss function Loss1. For example, the learning apparatus 1 may perform the machine learning of the learning model LM to increase the distance between the sample feature quantities SF1 and SF2 (i.e., to lower the degree of similarity between the sample feature quantities SF1 and SF2). Therefore, as compared with a case where the machine learning of the learning model LM is performed without using the distance loss function Loss2, the learning apparatus 1 is capable of performing the machine learning to hardly erroneously determine that the second sample person is the same as the second verification subject (i.e., to improve the accuracy of the verification processing) in the situation where the sample persons SP1 and SP2 are captured in one sample image SI. Consequently, the person verification apparatus 2 using the learning model built by the learning apparatus 1, is less likely to erroneously determine that the second target person TP is the same as the verification subject IP_T, even when one target image TI includes not only the first target person TP who is the same as the verification subject IP_T, but also the second target person TP who is not the same as the verification subject IP_T.

As described above, the learning apparatus 1 is capable of performing the machine learning of the learning model LM such that the first target person TP is properly determined to be the same as the verification subject IP_T by the person verification apparatus 2 and such that the second target person TP is not erroneously determined to be the same as the verification subject IP T, in the situation where one target image TI includes not only the first target person TP who is the same as the verification subject IP_T, but also the second target person TP who is not the same as the verification subject IP_T. Consequently, the person verification apparatus 2 is capable of properly determining that the first target person TP is the same as the verification subject IP_T, in the situation where one target image TI includes not only the first target person TP who is the same as the verification subject IP_T, but also the second target person TP who is not the same as the verification subject IP_T.

Especially in the first example embodiment in which the machine learning of the learning model LM is performed by using both the verification loss function Loss1 and the distance loss function Loss2, the accuracy of the verification processing is improved in the situation where one target image TI includes not only the first target person TP who is the same as the verification subject IP_T, but also the second target person TP who is not the same as the verification subject IP_T, as compared with a case where the machine learning of the learning model LM is performed without using at least one of the verification loss function Loss1 and the distance loss function Loss2. Consequently, even if a part of the first target person TP is hidden/covered by the second target person TP in one target image TI, the person verification apparatus 2 is capable of properly determining that the first target person TP is the same as the verification subject IP_T.

Furthermore, in the second example embodiment, the learning model LM to which the sample image SI is inputted, is capable of outputting the feature map MP and the bounding box Bb (i.e., the map position information indicating the position of the map area MA) as illustrated in FIG. 9. In this instance, the feature extraction unit 111 is capable of easily extracting the sample feature quantity SF by using the feature map MP and the bounding box Bb. Especially, even when a plurality of sample persons SP are captured in one sample image SI, the learning model LM is capable of outputting a plurality of bounding boxes Bb respectively corresponding to the plurality of sample persons SP. The feature extraction unit 111 is capable of easily extracting the sample feature quantities SF of the plurality of sample persons SP

### (3) Modified Examples

### (3-1) Learning Apparatus 1 in Modified Example

As described above, the learning dataset 121 includes the person position label 1214 indicating the bounding box Bb to be outputted by the learning model LM to which the sample image SI is inputted. In this instance, in the step S103 in FIG. 10, the learning unit 112 may calculate a position loss function Loss3 regarding the position of the bounding box Bb, in addition to the verification loss function Loss1 and the distance loss function Loss2. The position loss function Loss3 may be a loss function regarding an error between the position of the bounding box Bb actually outputted by the learning model LM to which the sample image SI is inputted, and the position of the bounding box Bb indicated by the person position label 1214. The position loss function Loss3 may be a loss function that becomes smaller as the error becomes smaller between the position of the bounding box Bb actually outputted by the learning model LM and the position of the bounding box Bb indicated by the person position label 1214.

In this instance, the learning unit 112 may calculate an error between the position of the bounding box Bb actually outputted by the learning model LM to which one sample image SI is inputted, and the position of the bounding box Bb indicated by the person position label 1214 corresponding to the one sample image SI. When a plurality of sample persons SP are captured in the sample image SI, the learning unit 112 may calculate an error corresponding to each sample person SP. For example, the learning unit 112 may calculate an error corresponding to the sample person SP1 and an error corresponding to the sample person SP2. The learning unit 112 may repeat the same processing by the number of the sample images SI inputted to the learning model LM. Thereafter, the learning unit 112 may calculate a sum of a plurality of calculated errors (or any arithmetic value or statistic) as the verification loss function Loss3.

When the position loss function Loss3 is calculated, in the step S103 in FIG. 10, the learning unit 112 may calculate an integrated loss function Loss obtained by integrating the verification loss function Loss1, the distance loss function Loss2, and the position loss function Loss3. As a consequence, the learning model LM is capable of outputting the bounding box Bb that designates the map area properly including the feature quantity of the sample person SP, of the feature map MP.

In addition, when the position loss function Loss3 is not calculated, the learning dataset 121 (especially, the correct answer label 1212) may not include the person position label 1214.

### (3-2) Person Verification Apparatus 2 in Modified Example

When a plurality of target persons TP are captured in the target image TI, the verification unit 213 may calculate the degree of similarity between each of the plurality of target persons TP and each of the plurality of different verification subjects IP_T as described above. However, as the number of the target persons TP increases, and/or as the number of the verification subjects IP_T increases, calculation cost for calculating the degree of similarity increases. Therefore, the verification unit 213 may select at least one target person TP for whom the degree of similarity is to be calculated, on the basis of the target feature quantities TF of the plurality of target persons TP, and may calculate the degree of similarity between the selected at least one target person TP and each of the plurality of different verification subjects IP_T. In this case, it is possible to reduce the calculation cost for calculating the degree of similarity (i.e., calculation cost required for the verification processing).

As an example, when the target feature quantities TF of the plurality of target persons TP include one target feature quantity TF that is the same as or similar to a target feature quantity TF extracted by the verification processing using another target image TI in the past, the verification unit 213 may exclude the target person TP corresponding to the one target feature quantity TF, from a calculation target of the degree of similarity. This is because it is likely that the target person TP corresponding to the one target feature quantity TF is already determined to be the same as another verification subject IP_T in the previous verification processing.

### (4) Supplementary Notes

With respect to the example embodiments described above, the following Supplementary Notes are further disclosed.

### Supplementary Note 1

A learning apparatus that performs machine learning of a learning model capable of outputting a feature quantity of a person when a person image including the person is inputted, the learning apparatus including:
an extraction unit that extracts a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and
a learning unit that performs the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

### Supplementary Note 2

The learning apparatus according to Supplementary Note 1, wherein
the first loss function is a loss function that becomes smaller as a probability increases that the first sample person is determined, by the verification processing, to be the same as the verification subject,
the second loss function is a loss function that becomes smaller as the distance is increased, and
the learning unit performs the machine learning such that an integrated loss function obtained by integrating the first and second loss functions becomes smaller.

### Supplementary Note 3

The learning apparatus according to Supplementary Note 1 or 2, wherein
the learning model to which the sample image is inputted, outputs a feature map indicating a feature of the sample image, and area information about a first map area corresponding to the first sample person of the feature map, and a second map area corresponding to the second sample person of the feature map, and
the extraction unit extracts the first sample feature quantity by using the first map area in the feature map, and extracts the second sample feature quantity by using the second map area in the feature map.

### Supplementary Note 4

The learning apparatus according to Supplementary Note 3, wherein
position information indicating a position of the first map area and a position of the second map area in the feature map, is given to the sample image as a correct answer label, and
the learning unit performs the machine learning by using a third loss function regarding respective errors between the positions of the first and second maps area outputted by the learning model and the positions of the first and second maps area given as the correct answer label.

### Supplementary Note 5

A person verification apparatus including:
an extraction unit that extracts a target feature quantity that is a feature quantity of a target person, by inputting, as a person image, a target image including the target image, to a learning model capable of outputting a feature quantity of a person when the person image including the person is inputted; and
a verification unit that determines whether or not the target person captured in the target image is the same as a first verification subject, on the basis of the target feature quantity, wherein
the learning model is already learned by a learning method including:
extracting a first sample feature quantity that is a feature quantity of a first sample person and a second sample feature quantity that is a feature quantity of a second sample person, by inputting, as the person image, a sample image including the first sample person who is the same as a second verification subject and the second sample person who is different from the first sample person, to the learning model; and
performing machine learning of the learning model by using a first loss function regarding accuracy of verification processing of determining, on the basis of the first sample feature quantity, whether or not the first sample person captured in the sample image is the same as the second verification subject, and by using a second loss function regarding a distance between the first and second sample feature quantities.

### Supplementary Note 6

The person verification apparatus according to Supplementary Note 5, wherein
a plurality of target persons are captured in the target image, and
the verification unit determines whether each of the plurality of target persons captured in target image is the same as the first verification subject, by comparing the target feature quantity of each of the plurality of target persons with a verification subject feature quantity that is a feature quantity of the first verification subject.

### Supplementary Note 7

A learning method that performs machine learning of a learning model capable of outputting a feature quantity of a person when a person image including the person is inputted, the learning method including:
extracting a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and
performing the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

### Supplementary Note 8

A person verification method including:
extracting a target feature quantity that is a feature quantity of a target person, by inputting, as a person image, a target image including the target image, to a learning model capable of outputting a feature quantity of a person when the person image including the person is inputted; and
determining whether or not the target person captured in the target image is the same as a first verification subject, on the basis of the target feature quantity, wherein
the learning model is already learned by a learning method including:
extracting a first sample feature quantity that is a feature quantity of a first sample person and a second sample feature quantity that is a feature quantity of a second sample person, by inputting, as the person image, a sample image including the first sample person who is the same as a second verification subject and the second sample person who is different from the first sample person, to the learning model; and
performing machine learning of the learning model by using a first loss function regarding accuracy of verification processing of determining, on the basis of the first sample feature quantity, whether or not the first sample person captured in the sample image is the same as the second verification subject, and by using a second loss function regarding a distance between the first and second sample feature quantities.

### Supplementary Note 9

A recording medium on which a computer program that allows a computer to execute a learning method is recorded, the learning method performing machine learning of a learning model capable of outputting a feature quantity of a person when a person image including the person is inputted,
the learning method including:
extracting a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and
performing the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

### Supplementary Note 10

A recording medium on which a computer program that allows a computer to execute a person verification method is recorded,
the person verification method including:
extracting a target feature quantity that is a feature quantity of a target person, by inputting, as a person image, a target image including the target image, to a learning model capable of outputting a feature quantity of a person when the person image including the person is inputted; and
determining whether or not the target person captured in the target image is the same as a first verification subject, on the basis of the target feature quantity, wherein
the learning model is already learned by a learning method including:
extracting a first sample feature quantity that is a feature quantity of a first sample person and a second sample feature quantity that is a feature quantity of a second sample person, by inputting, as the person image, a sample image including the first sample person who is the same as a second verification subject and the second sample person who is different from the first sample person, to the learning model; and
performing machine learning of the learning model by using a first loss function regarding accuracy of verification processing of determining, on the basis of the first sample feature quantity, whether or not the first sample person captured in the sample image is the same as the second verification subject, and by using a second loss function regarding a distance between the first and second sample feature quantities.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is permitted to be changed, if desired, without departing from the essence or spirit of this disclosure which can be read from the claims and the entire identification. A learning apparatus, a learning method, a person verification apparatus, a person verification method, and a recording medium with such changes are also intended to be in the technical scope of this disclosure.

### DESCRIPTION OF REFERENCE CODES

1000 Learning apparatus
1001 Extraction unit
1002 Learning unit
2000 Person verification apparatus
2001 Extraction unit
2002 Verification unit
1 Learning apparatus
11 Arithmetic apparatus
111 Feature extraction unit
112 Learning unit
12 Storage apparatus
121 Learning dataset
1210 Unit learning data
1211 Sample image
1212 Correct answer label
1213 Person identification label
1214 Person position label
2 Person verification apparatus
21 Arithmetic apparatus
211 Image generation unit
212 Feature extraction unit
213 Verification unit
SP, SP1, SP2 Sample person
TP Target person
IP_S, IP_T Verification subject
SF, SF1, SF2 Sample feature quantity
TF Target feature quantity
LM Learning model
MP Feature map
MA Map area
Bb Bounding box

What is claimed is:

1. A learning apparatus that performs machine learning of a learning model capable of outputting a feature quantity of a person when a person image including the person is inputted, the learning apparatus comprising:
at least one memory configured to store instructions; and
at least one processor configured to execute the instructions to:
extract a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and
perform the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

2. The learning apparatus according to claim 1, wherein
the first loss function is a loss function that becomes smaller as a probability increases that the first sample person is determined, by the verification processing, to be the same as the verification subject,
the second loss function is a loss function that becomes smaller as the distance is increased, and
the at least one processor configured to execute the instructions to perform the machine learning such that an integrated loss function obtained by integrating the first and second loss functions becomes smaller.

3. The learning apparatus according to claim 1, wherein
the learning model to which the sample image is inputted, outputs a feature map indicating a feature of the sample image, and area information about a first map area corresponding to the first sample person of the feature map, and a second map area corresponding to the second sample person of the feature map, and
the at least one processor configured to execute the instructions to extract the first sample feature quantity by using the first map area in the feature map, and extracts the second sample feature quantity by using the second map area in the feature map.

4. The learning apparatus according to claim 3, wherein
position information indicating a position of the first map area and a position of the second map area in the feature map, is given to the sample image as a correct answer label, and
the at least one processor configured to execute the instructions to perform the machine learning by using a third loss function regarding respective errors between the positions of the first and second maps area outputted by the learning model and the positions of the first and second maps area given as the correct answer label.

5. A person verification apparatus comprising:
at least one memory configured to store instructions; and
at least one processor configured to execute the instructions to:
extract a target feature quantity that is a feature quantity of a target person, by inputting, as a person image, a target image including the target image, to a learning model capable of outputting a feature quantity of a person when the person image including the person is inputted; and
determine whether or not the target person captured in the target image is the same as a first verification subject, on the basis of the target feature quantity, wherein
the learning model is already learned by a learning method including:
extracting a first sample feature quantity that is a feature quantity of a first sample person and a second sample feature quantity that is a feature quantity of a second sample person, by inputting, as the person image, a sample image including the first sample person who is the same as a second verification subject and the second sample person who is different from the first sample person, to the learning model; and
performing machine learning of the learning model by using a first loss function regarding accuracy of verification processing of determining, on the basis of the first sample feature quantity, whether or not the first sample person captured in the sample image is the same as the second verification subject, and by using a second loss function regarding a distance between the first and second sample feature quantities.

6. The person verification apparatus according to claim 5, wherein
a plurality of target persons are captured in the target image, and
the at least one processor configured to execute the instructions to determine whether each of the plurality of target persons captured in target image is the same as the first verification subject, by comparing the target feature quantity of each of the plurality of target persons with a verification subject feature quantity that is a feature quantity of the first verification subject.

7. A learning method that performs machine learning of a learning model capable of outputting a feature quantity of a person when a person image including the person is inputted, the learning method comprising:
extracting a first sample feature quantity that is a feature quantity of a first sample person and a second sample feature quantity that is a feature quantity of a second sample person, by inputting, as the person image, a sample image including the first sample person who is the same as a verification subject and the second sample person who is different from the first sample person, to the learning model; and
performing the machine learning by using a first loss function regarding accuracy of verification processing of determining, on the basis of the first sample feature quantity, whether or not the first sample person captured in the sample image is the same as the verification subject, and by using a second loss function regarding a distance between the first and second sample feature quantities.

8-10. (canceled)
